(19) United States
(12) Patent Application Publication
(10) Pub. No.: US 2003/0169212 A1
(43) Pub. Date: Sep. 11, 2003

(54) Portable electronic device

(76) Inventor: Makoto Nishihara, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/354,667

(22) Filed: Jan. 30, 2003

(30) Foreign Application Priority Data
Feb. 1, 2002 (JP) 2002-024988

(51) Int. Cl. G09G 5/00

(52) U.S. Cl. 345/1.1

(57) ABSTRACT

In order to arbitrarily and freely change a display position and a display direction of a sub display on a housing, in a portable electronic device having a main display and an operation unit provided on a front face of a housing accommodating system constituting elements therein, a sub display is rotatably supported in an accommodation unit provided at an upper edge of the housing excluding the front face, and a display screen of the sub display is supported so as to have both a readable state in which the display screen faces toward outside the housing, that is, toward the front face, a top surface and a back face, and a not-readable state in which the display screen faces toward inside the housing being inside the accommodation unit.

### CROSS REFERENCES TO RELATED APPLICATIONS

The present document is based on Japanese Priority Document JP 2002-024988, filed in the Japanese Patent Office on Feb. 1, 2002, the entire contents of which being incorporated herein by reference.

### BACKGROUND OF THE INVENTION

1. Field of the Invention

The present invention relates to portable electronic devices including mobile phones, in particular, to those having a sub display in addition to a main display.

2. Description of the Related Art

In recent portable electronic devices, in particular, foldable mobile phones, there are those having a sub display functioning as a supplemental display provided at a position on an outer surface, such as a back face of the foldable housing, in addition to a main display comprising a liquid crystal panel. Such a sub display comprises a liquid crystal panel and is utilized for clock display, indication of receiving calls/mails, indication of caller/sender and the like. In a case where such a sub display is fixed on an outer surface of the housing, it is usual that, since the usage of the sub display is limited to a simple function such as a clock display, the sub display comprises a black-white liquid crystal panel available in a lower cost.

### SUMMARY OF THE INVENTION

Since positions and directions of the sub displays employed in conventional mobile phones are restricted in this way, it is almost impossible for a user to purchase a mobile phone having a sub display on a position/direction that he/she prefers, and thus, there is few possibility that the user is completely satisfied with his/her purchase. In addition, in order to highly improve utility value of the mobile phones, it is desirable that the sub display comprises a color liquid crystal panel capable of variety of expressions. However, the sub display conventionally employed is provided fixedly on a back face of a housing of the mobile phone, in most cases. Even if the sub display comprises the color liquid crystal panel, it only functions as a clock display, an incoming-call display or the like. In short, employment of a color liquid crystal display in the sub display does not improve the utility value of the mobile phone. On this account, there is a demand for freely arranging the sub display on any position including a front face and a back face of the housing.

In other words, there is a need for a portable electronic device in which a display position and a display direction of a sub display in a housing thereof can be arbitrarily and freely changed. There is another need for a portable electronic device in which a sub display is changeable in accordance with a user's preference.

In order to meet such a need, the present invention provides a portable electronic device having a housing accommodating electronic system elements therein, in which a main display and an operation unit are provided on a front face of said housing. In the device, a sub display separate from the main display is movably provided on any desired position on the housing other than the front face so that direction of a display screen thereof can be changed. According to the portable electronic device of the present invention, a display position and a display direction of a sub display in a housing thereof can be arbitrarily and freely changed in accordance with a user's preference.

In order to meet the other need, the present invention also provides a portable electronic device having a housing accommodating electronic system elements therein, in which a main display and an operation unit are provided on a front face of the housing. In the device, a sub display separate from the main display is detachably provided on any desired position on the housing other than the front face. According to the portable electronic device of the present invention, mounting of the sub display on the housing can be freely changed in accordance with the user's preference and the user can selectively mount his/her favorite sub display on the housing.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a perspective view showing a first embodiment of a case where the present invention is applied to a mobile phone.

FIG. 2 is an enlarged perspective view of a main part of the mobile phone of the first embodiment.

FIG. 3 is a perspective view of a sub display in the first embodiment of the present invention.

FIG. 4A is a view for explaining an example of wiring for the sub display in the first embodiment of the present invention, FIG. 4B is a view for explaining another example of wiring for the sub display in the first embodiment of the present invention.

FIG. 5 is a view showing a system configuration of the mobile phone according to the first embodiment of the present invention.

FIG. 6 is a front view showing a part of a mobile phone of a second embodiment of the present invention.

FIG. 7 is a perspective view showing a part of a mobile phone of a third embodiment of the present invention.

FIG. 8 is a perspective view showing a part of a mobile phone of a fourth embodiment of the present invention.

FIG. 9A is a perspective view showing a part of a mobile phone of a fifth embodiment of the present invention, FIG. 9B is a perspective view showing an example of a sub display, and FIG. 9C is a perspective view showing another example of the sub display.

FIG. 10 is a perspective view showing a part of a mobile phone of a sixth embodiment of the present invention.

### DESCRIPTION OF THE PREFERRED EMBODIMENTS

Hereinafter, embodiments of a portable electronic device of the present invention will be described in detail with reference to the attached drawings.

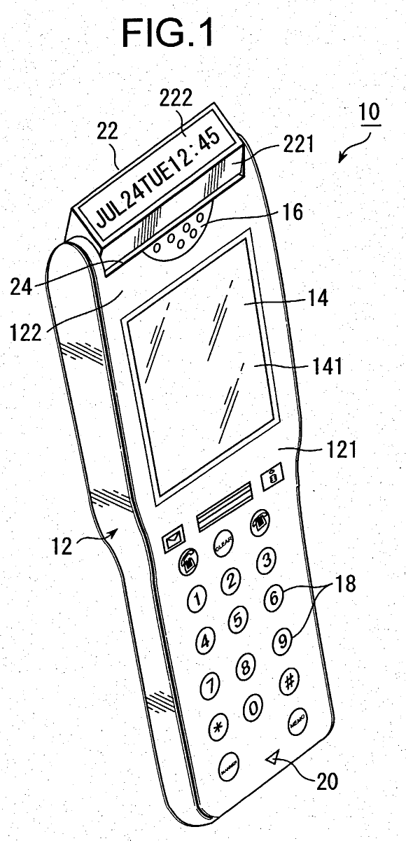

In FIG. 1, a box-type mobile phone 10 comprises a housing 12 in which elements constituting the mobile phone are accommodated and held. The term “box-type” used here simply means that the housing is in a rectangular solid shape like a box. At an upper portion of a front face 121 of the housing 12, there are provided a main display 14 and a speaker 16. The main display 14 has a relatively large rectangular display screen 141 comprising a color liquid crystal panel. At a lower portion of the front face 121 of the housing, there are provided an operation unit 18 comprising numerical keys and the like, a microphone 20 and so on. A display separate from the main display 14 is provided as a sub display 22. An accommodation unit 24 is formed to be a concave by cutting an upper edge 122 of the housing 12 positioned in the vicinity around the main display 14. The accommodation unit 24 supports the sub display 22 rotatably.

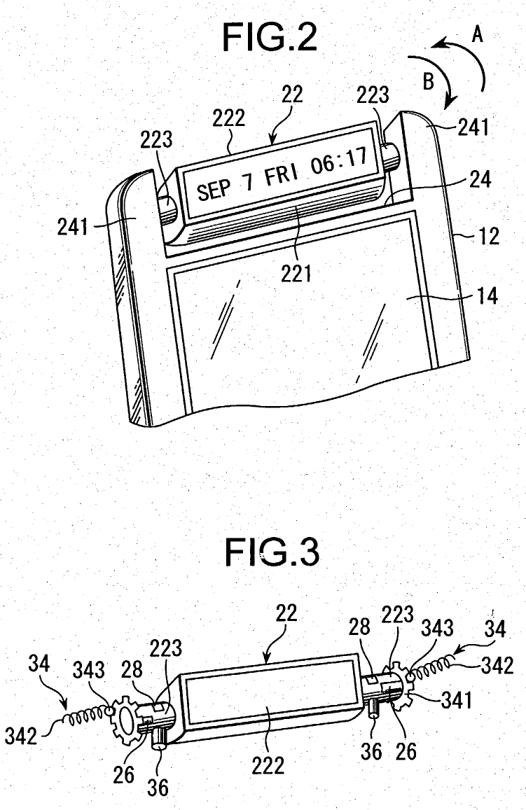

The sub display 22 comprises a color liquid crystal panel. As shown in FIG. 1 and FIG. 2, the entire sub display 22 is mounted in a sub display housing 221 and has a display screen 222 which is long in a horizontal direction. In addition, on both sides of the housing 221 in a longitudinal direction, cylindrical axes 223 are protrudingly provided to have the same axis line. The axes 223 are rotatably supported by supports 241 at both sides of the accommodation unit 24.

On a peripheral surface of the axes 223, a face-front detecting electrode 26 and a face-back detecting electrode 28 are respectively provided, as shown in FIG. 3. The face-front detecting electrode 26 detects that the display screen 222 of the sub display 22 faces toward the front face of the housing 12. The face-back detecting electrode 28 detects that the sub display screen 222 of the sub display 22 rotates 180 degrees relative to the state shown in FIG. 2 to face toward a back face of the housing 12.

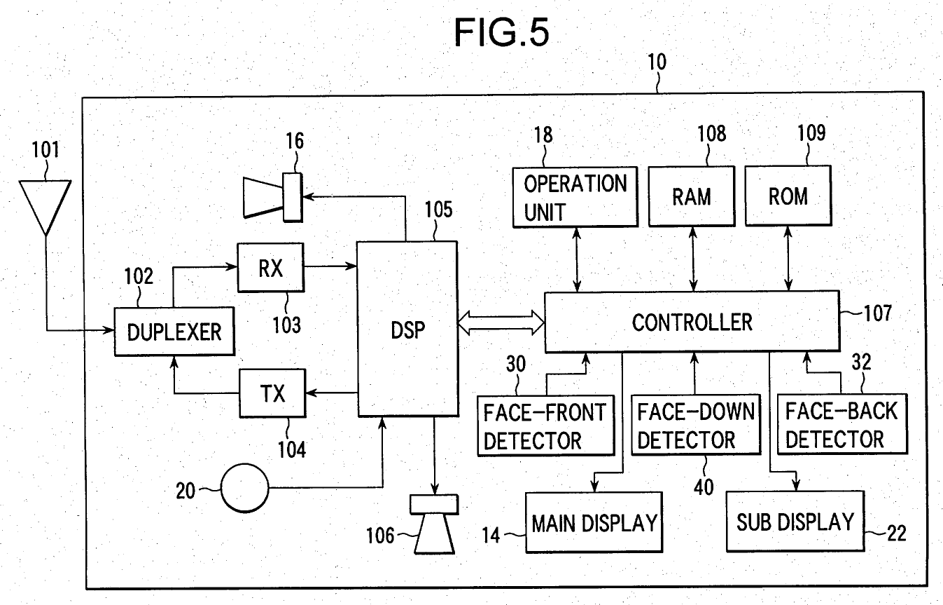

Inside the supports 241, a face-front detector 30 and a face-back detector 32 are respectively provided (See FIG. 5). The face-front detector 30 detects that the display screen 222 of the sub display 22 faces toward the front face by contacting with the face-front detecting electrode 26 and transmits a signal. The face-back detector 32 detects that the display screen 222 of the sub display 22 faces toward the back face by contacting with the face-back detecting electrode 28 and transmits a signal.

Click means 34 are provided at the both axes 223 for favorably restraining rotation of the sub display 22. Each of the click means 34 comprises a gear-shaped disc 341 and a steel ball 343. The gear-shaped disc 341 is fixed at each tip of the axes 223. The steel ball 343 is provided inside the both supports 241, pressed onto the gear portion of the disc 341 by a spring member 342. Each of the axes 223 is also provided with a stopper (not shown) and a lock piece 36, provided at each of the supports 241, for locking the sub display 22 so as not to rotate more than 360 degrees.

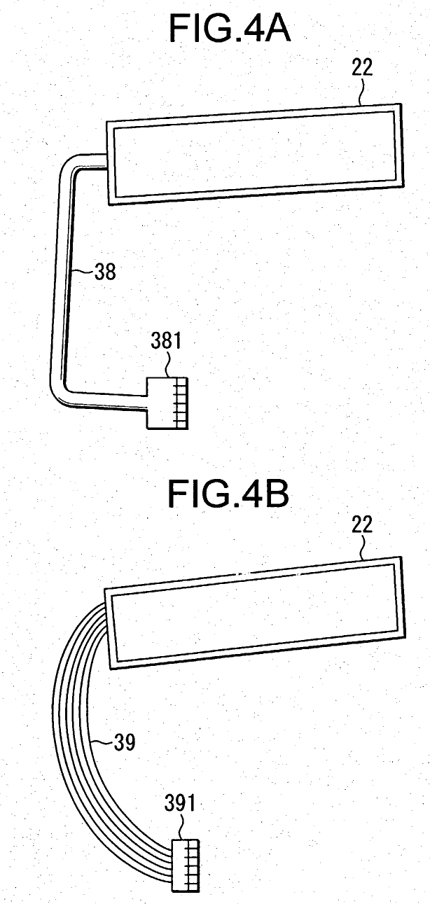

At one end of the sub display 22, as shown in FIG. 4A, one end of a flexible wiring 38 is connected thereto. The flexible wiring 38 is drawn out through the cylindrical axis 223 and the other end thereof is connected to a display controller (not shown) through a connector 381 provided thereto. The wiring used for connecting the sub display 22 and the not-shown display controller is not limited to the above-described flexible wiring. For example, as shown in FIG. 4B, one end of a harness 39 comprising tied-up cables is connected to the sub display 22 and the other end of the harness 39 is connected to the not-shown display controller through a connector provided thereto.

Now, a system configuration of the mobile phone 10 shown in FIG. 5 will be described below. In FIG. 5, designated at 101 is an antenna for transmission and reception. A receiver circuit (RX) 103 and a transmitter circuit (TX) 104 are connected to the antenna 101 via a duplexer 102. The receiver circuit 103 and the transmitter circuit 104 are further connected to a signal processing circuit (Digital Signal Processor: DSP) 105.

The DSP 105 D-A converts demodulated incoming call information to output it to an incoming-call speaker 106 and inform a user of the mobile phone 10 of an incoming call. In addition, a voice signal demodulated in the receiver circuit 103 is subject to D-A conversion in the DSP 105 to be outputted to the speaker 16. A voice signal picked up by the microphone 20 is subject to A-D conversion at the DSP 105 and modulation at the transmitter circuit 104 so as to be transmitted from the duplexer 102 through the antenna 101.

Designated at 107 is a controller for controlling and managing operation of the whole mobile phone 10. The main display 14, the operation unit 18, the sub display 22, the face-front detector 30, the face-back detector 32, a RAM 108 and a ROM 109 are respectively connected to the controller 107, and further, to the DSP 105.

In the mobile phone 10 as constructed above, in a case where the display screen 222 of the sub display 22 is set to face toward the front face of the housing 12, as shown in FIG. 2, the face-front detecting electrode 26 contacts the face-front detector 30 so that a detection signal is taken from the face-front detector 30 into the controller 107. Accordingly, information including month, date, time and the like as shown in FIG. 2, for example, is displayed on the display screen 222 of the sub display 22. In addition, in a case of incoming call, a message such as “incoming call” is displayed in text together with the name of a caller on the display screen 222 of the sub display 22.

In addition, in the case where the display screen 222 of the sub display 22 faces toward the front face of the housing 12, by making the sub display 22 virtually in conjunction with the main display 14, the displays can be used as a single display of a large size. Furthermore, each item of the operation menu of the mobile phone can be displayed as an icon on the sub display 22 and contents corresponding to the icon can be displayed on the main display 14. Accordingly, usable area on the main display 14 can be larger and an application currently in use can be quickly changed to another application. Furthermore, it is possible to change only a display screen on the main display 14 without changing the display screen on the sub display 22, or, conversely, to change only the display screen on the sub display 22 without changing the display screen on the main display 14. Thus, new utilization and new application can be created. For example, such an idea that advertisement continuously shown on the sub display 22 makes packet transmission charges free can be possible.

In addition, if the sub display 22 is rotated 90 degrees from the position shown in FIG. 2 and is clicked and stopped at the position, the display screen 222 of the sub display 22 can face toward a top surface of the housing 12. Therefore, even if the mobile phone 10 is kept in a breast pocket of a shirt or a jacket, the user can easily read the contents displayed on the sub display 22 facing skyward. In particular, in a case where the present invention is applied to a foldable flip-type mobile phone, it is possible to easily read the display of date and time or the name of a caller without opening the mobile phone and without reading the main display 14.

Furthermore, if the sub display 22 is rotated 180 degrees from the position shown in FIG. 2 and is clicked and stopped at the position, the display screen 222 of the sub display 22 can face toward a back face of the housing 12. In this case, the face-back detecting electrode 28 contacts the face-back detector 32 so that a detection signal is taken from the face-back detector 32 into the controller 107. Accordingly, the display contents on the display screen 222 of the sub display 22 are controlled to be inversed upside-down and reversed horizontally. Therefore, even if viewed from the back of the housing 12, information such as date and time as shown in FIG. 2 is displayed on the display screen 222 of the sub display 22. Of course, in a case of incoming call, a message including “incoming call” and the name of the caller is displayed in an easily readable manner, that is, from left to right in a case of English text, for example, on the display screen 222 of the sub display 22, which can be visually recognized without feeling odd.

Furthermore, if the sub display 22 is rotated 90 degrees from a position shown in FIG. 2 in a direction of the arrow B and is clicked and stopped at the position, the display screen 222 of the sub display 22 is accommodated facing down in the accommodation unit 24. In other words, the sub display 22 is supported to have both of the two modes: a readable mode in which the display screen 222 faces toward outside of the housing 12 and a non-readable mode in which the display screen 222 faces toward inside the housing 12. In the case of the non-readable case, the sub display is switched to a standby mode.

Accordingly, the face-down detector 40 (having a similar structure to the face-back detecting electrode 28 and the face-back detector 32, as shown in FIG. 5) for detecting that the display screen 222 of the sub display 22 faces down operates so that a detected signal is taken into the controller 107. With this operation, the controller 107 controls the sub display 22 to be switched to the standby mode. Therefore, wasteful power consumption in the sub display 22 can be avoided and the liquid crystal display screen 222 thereof can be protected.

According to the first embodiment as described above, since the sub display 22 is rotatably supported in the accommodation unit 24 formed at the upper edge 122 of the housing 12 positioned in the vicinity around the main display 14, and it is constructed to support the display screen 222 of the sub display 22 to have both the visibly readable mode in which it faces toward frontward, upward and backward in relation to the housing 12 and the visibly unreadable mode in which it faces toward inside the housing 12, that is, inside the accommodation unit 24, the above-described effects can be obtained, and in addition thereto, the direction of the display on the display screen 222 of the sub display 22 can be arbitrarily and freely changed in accordance with a user's request. By constituting the sub display 22 with a color liquid crystal panel, colorful and attractive display can be made and, in addition, it is also possible to display on the sub display 22 date, the name of a caller or a sender, mail-contents, setting information and so on.

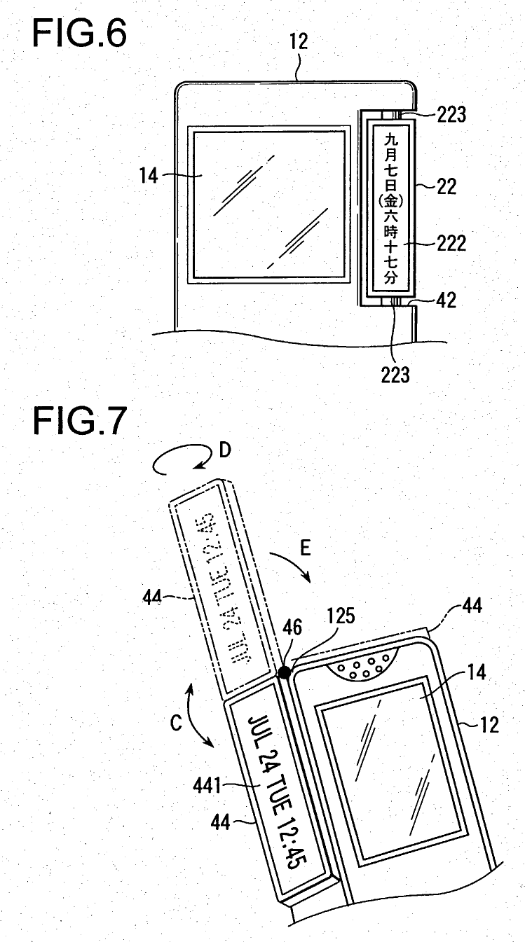

Next, with reference to FIG. 6, a second embodiment of the mobile phone in accordance with the present invention will be described. FIG. 6 is a front view of a part of a mobile phone of the second embodiment of the present invention. In the present specification, an element having a similar function to that in the first embodiment will be shown with the same reference numeral.

In FIG. 6, a right side of a housing 12 positioned near and right of a main display 14 is cut away to have an accommodation unit 42 of a concave shape. In the accommodation unit 42, axes 223 supports a sub display 22 constituted in a similar way to the case of FIG. 3 rotatably. In this case, contents are displayed on the display screen 222 of the sub display 22 in a vertical direction. In this figure, the display is in Japanese (Chinese characters) and reads: September 7, Friday, 06:17.

According to the second embodiment of the present invention, operation and effects similar to those of the first embodiment shown in FIG. 1 and FIG. 2 can also be obtained. In addition, it is also possible to make the display screen 222 of the sub display 22 face toward outer side of the housing 12 and the display can be made on one of the side faces of the housing 12. This enables further change in display direction.

Next, with reference to FIG. 7, a third embodiment of the mobile phone of the present invention will be described. FIG. 7 is a perspective view showing a part of the mobile phone of the third embodiment of the present invention.

In the third embodiment of the present invention, one end of a sub display 44 comprising a strip-like color liquid crystal display is attached swingably in a direction of the arrow C and rotatably in a direction of arrow D using a pivot 46 at an upper end corner portion 125 of a housing 12. According to the arrangement, the sub display 44 can be set switchably between the side surface and the top of the housing 12. The sub display 44 and a not-shown drive circuit provided inside the housing 12 are connected with a not-shown flexible line wired through the pivot 46.

In such a mobile phone, in a case of displaying the contents on the sub display 44 on the side surface of the housing 12, the sub display 44 is set at a position shown in a solid line in FIG. 7. In a case of displaying the contents on the sub display 44 on the top of the housing 12, after the sub display 46 is rotated using the pivot 46 as a fulcrum 180 degrees in the direction of the arrow C from the position shown in the solid line in FIG. 7, the sub display 44 is rotated with the pivot as a center 180 degrees in the direction of the arrow D to be positioned at a place shown in a phantom line and then, the display is inclined in an direction of an arrow E to be set at the top of the housing 12.

After the sub display 44 is rotated 180 degrees in the direction of the arrow C, if the sub display 44 is rotated 180 degrees in the direction of the arrow D and is rotated 180 degrees in an opposite direction to the arrow C, a display screen 441 of the sub display 44 faces toward inside and the display screen 441 can be protected. In addition, the sub display 44 is arranged so that a power supply thereto is cut off at that state, wasteful power consumption in the sub display 44 can be avoided.

According to the third embodiment as described above, effects almost similar to the first embodiment can be obtained.

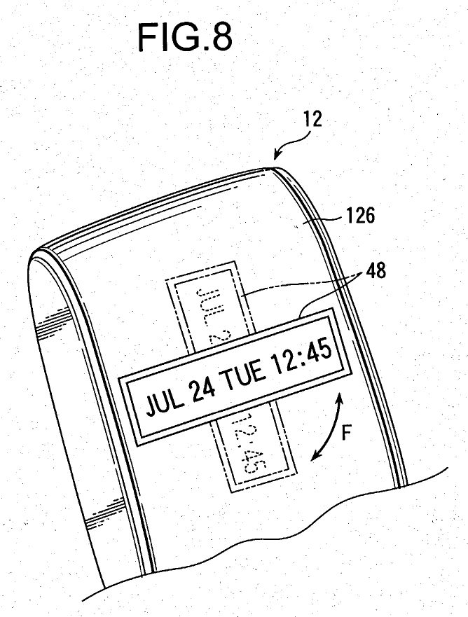

With reference to FIG. 8, a fourth embodiment of a mobile phone of the present invention will be described. FIG. 8 is a perspective view showing a part of the mobile phone of the fourth embodiment of the present invention.

In the fourth embodiment, a center portion of a sub display 48 comprising a color liquid crystal panel having a shape of a strip is attached on a back face 126 of a housing 12 using a not-shown support member rotatably in a direction of an arrow F. The sub display 48 and a not-shown drive circuit provided inside the housing 12 are connected with a not-shown flexible line or a harness wired through the support member. The sub display 48 applied to the fourth embodiment is not limited to be a strip shape but may be a square, a circular shape or the like.

In such a mobile phone, if the sub display 48 shown in a solid line in FIG. 8 is rotated 90 degrees, the horizontal sub display 48 can be made vertical as shown in a phantom line. In this case, by providing a detector (not shown) for detecting that the sub display 48 is vertically positioned, it is also possible to display vertically the contents on a display screen 481 of the sub display 48 in accordance with the detection result.

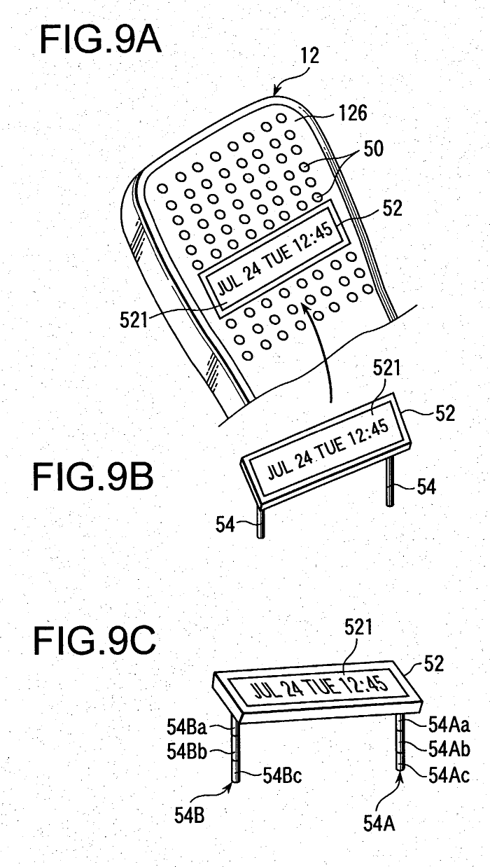

Next, a fifth embodiment of a mobile phone according to the present invention will be described with reference to FIGS. 9A-9C. FIG. 9A is a perspective view showing a part of the mobile phone of the fifth embodiment of the present invention. FIG. 9B is a perspective view showing an example of a sub display. FIG. 9C is a perspective view showing another example of the sub display.

In the fifth embodiment of the present invention, as shown in FIG. 9A, on a back face 126 of a housing 12 are provided a number of pin holes 50 at fixed intervals as in a matrix. Each of the pin holes 50 is provided with an electrode for electrically communicating with a control circuit built in the housing 12. Designated at 52 is a sub display comprising a color liquid crystal panel in a strip shape. On both side portions on the back of the sub display 52 are provided a pair of pins 54 having different length, each of which fits into one of the pin holes 50, as shown in FIG. 9B. In a state that the pair of pins 54 are engaged into the pin holes 50, it is judged using a not-shown control circuit in which direction one of the pins 54 is positioned with regard to the back face 126 of the housing 12. According to the judgement result, the direction of the sub display 52 can be determined. In accordance with the determined direction of the sub display 52, characters can be displayed on a display screen 521 of the sub display 52 suitably for any of the directions of horizontal, vertical or slant.

In addition, as another example, as shown in FIG. 9C, there are provided a pair of pins 54A and 54B to be engaged into the pin holes 50. These pins 54A and 54B are made to have the same length. A power source terminal 54Aa, a data terminal 54Ab and a clock terminal 54Ac are serially provided on the pin 54A in a longitudinal direction thereof. In addition, a ground terminal 54Ba, a CS terminal 54Bb and a connection signal terminal 54Bc are serially provided on the pin 54B in a longitudinal direction thereof. In the sub display 52 having the pins 54A and 54B as described above, the position of the connection signal terminal 54Bc with regard to the back face 126 of the housing 12 is judged using a not-shown control circuit, similar to the above-explained case of FIG. 9B. In accordance with the judged direction of the sub display 52, characters can be displayed on the display screen 521 of the sub display 52 suitably for any of the directions of horizontal, vertical or slant.

According to the fifth embodiment of the present invention as described above, since the sub display 52 can be provided detachably on the back face 126 of the housing 12, it is possible to freely change the position of the sub display 52 on the housing 12 depending on user's preference, and it is also possible to selectively attach a sub display which the user prefers on the housing and to change the direction of the sub display in accordance with the user's preference. In addition, it is also possible to electrically connect the sub display 52 and a not-shown drive circuit provided in the housing 12 using the pins 54 and the pin holes 50. The sub display 52 applied to the fifth embodiment is not limited to that in the shape of a strip but may be the shape of a square or a circle.

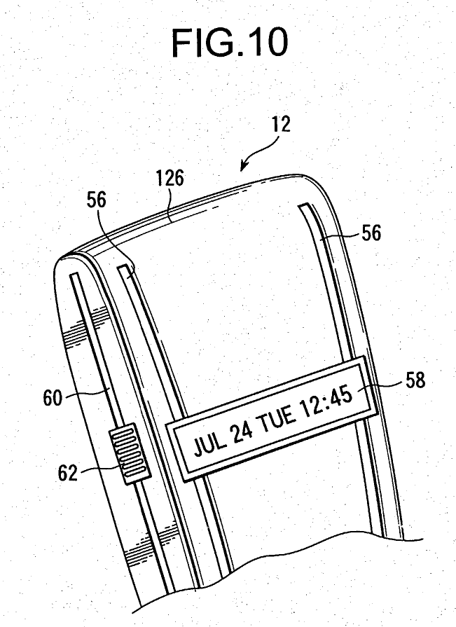

With reference to FIG. 10, a sixth embodiment of a mobile phone according to the present invention will be described. FIG. 10 is a perspective view showing a part of the mobile phone of the sixth embodiment of the present invention.

In the sixth embodiment, as shown in FIG. 10, there are formed a pair of guide grooves 56 extending in a vertical direction of a housing 12 and having a fixed interval therebetween in a horizontal direction of the housing 12. Designated at 58 is a sub display comprising a color liquid crystal panel in a strip shape. Both ends of the sub display 58 are slidably engaged in the guide grooves 56 by means of a not-shown support which also functions as a conductor. On a side of the housing 12, there is formed a tab-guide groove 60 in a vertical direction of the housing 12. An operation tab 62 is slidably provided on the tab-guide groove 60 so as to move the sub display 58 along the guide groove 56. The sub display 58 applied to the fifth embodiment is not limited to that in the shape of a strip but may be the shape of a square or a circle.

In the guide grooves 56 and 60, not-shown dust-tight means is provided to prevent dusts from invading into these grooves. According to the sixth embodiment, operating the tab 62 makes it possible to move and/or change the position of the sub display 58 as the user desires.

In the above embodiments, the case where the present invention is applied to a box-type mobile phone has been described. However, the present invention is not limited to the case and, of course, may be applied to a foldable flip-type mobile phone.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A portable electronic device having a housing accommodating electronic system elements therein, in which a main display and an operation unit are provided on a front face of the housing, wherein:
a sub display separate from said main display is movably provided on any desired position on said housing other than said front face so that direction of a display screen thereof can be changed.

2. A portable electronic device according to claim 1, wherein said sub display is provided on an upper edge or one of sides of said housing which is in a vicinity surrounding said main display or a back face of said housing.

3. A portable electronic device according to claim 2, wherein:
an accommodation unit capable of accommodating said sub display is provided at the upper edge or one of the sides of said housing, and
said sub display is rotatably supported in said accommodation unit so that said display screen of said sub display faces toward the front face, a top surface, the back face or a side of said housing.

4. A portable electronic device according to claim 3, wherein:
said sub display is rotatably supported so that said display screen of the sub display selectively faces one of the front face and the back face of said housing, and,
in a case where said display screen of the sub display faces toward the front face, contents displayed on the display screen are inversed upside-down and reversed horizontally relative to a case where the display screen faces toward the back face.

5. A portable electronic device according to claim 3, wherein:
a rotation support supports said sub display, and
said rotation support has click means for favorably restraining rotation of said sub display.

6. A portable electronic device according to claim 3, wherein:
said sub display is supported to have both a readable state where said display screen faces toward outside said housing and a not-readable state where said display screen faces toward inside said housing, and
when said sub display is in the not-readable state, the sub display is constituted to be switched to a standby mode.

7. A portable electronic device according to claim 1, wherein:
said main display and said sub display comprise a color liquid crystal panel.

8. A portable electronic device according to claim 1, wherein:
said housing is separated into a first housing in which said main display is provided and a second housing in which said operation unit is provided,
said first housing and said second housing are foldably connected with a hinge, and
said sub display is provided in said first housing.

9. A portable electronic device having a housing accommodating electronic system elements therein, in which a main display and an operation unit are provided on a front face of said housing, wherein:
a sub display separate from said main display is detachably provided on any desired position on said housing other than said front face.

10. A portable electronic device according to claim 9, wherein:
said sub display is provided on a back face of said housing.

11. A portable electronic device according to claim 10, wherein:
said sub display is constituted to be selectively provided horizontally, vertically and slantly on said back face of said housing.

12. A portable electronic device according to claim 9, wherein:
said main display and said sub display comprise a color liquid crystal panel.

13. A portable electronic device according to claim 9, wherein:
said housing is separated into a first housing in which said main display is provided and a second housing in which said operation unit is provided, and
said first housing and said second housing are foldably connected with a hinge.
